(19) United States
(12) Patent Application Publication
(10) Pub. No.: US 2012/0257899 A1
(43) Pub. Date: Oct. 11, 2012

(54) ORTHOGONAL BAND LAUNCH FOR REPEATERLESS SYSTEMS

(75) Inventors: Lee Richardson, Freehold, NJ (US); Ekaterina A. Golovchenko, Colts Neck, NJ (US); Bamdad Bakhshi, New York, NY (US)

(73) Assignee: TYCO ELECTRONICS SUBSEA COMMUNICATIONS LLC, Morristown, NJ (US)

(21) Appl. No.: 13/081,231

(22) Filed: Apr. 6, 2011

(51) Int. Cl. H04B 10/12; H04J 14/02

(52) U.S. Cl. 398/79; 398/184

(57) ABSTRACT

Briefly, in accordance with one or more embodiments, a band of signal carriers is divided into a first band of carriers and a second band of carriers. The carriers in the first band comprise shorter wavelength carriers, and carriers in the second band comprise longer wavelength carriers. Each of the optical sources in the first and second bands of carriers are modulated with an input signal and coupled together via a polarization maintaining coupler. These signals are then combined via a polarization beam combiner wherein the first band has a polarization state that is orthogonal, or nearly orthogonal, to a polarization of the second state.

### TECHNICAL FIELD

Embodiments of the present disclosure relate to the field of optical communication systems. More particularly, the present disclosure relates to orthogonal band launch used to increase capacity and reach of unrepeatered optical communication systems.

### DISCUSSION OF RELATED ART

In optical communication systems, wavelength division multiplexing (WDM) is used to transmit optical signals long distances where a plurality of optical channels each at a particular wavelength propagate over fiber optic cables. However, certain optical communication systems, in particular long-haul networks of lengths greater than about 500 kilometers, inevitably suffer from deleterious effects due to a variety of factors including scattering, absorption, and/or bending. To compensate for losses, optical amplifiers are typically placed at regular intervals, for example about every 50 kilometers, to repeat and boost the optical signal. However, such repeatered systems may be expensive to build and maintain in contrast to repeaterless systems that do not rely on multiple optical amplifiers to boost the optical signal.

Despite fairly complex transmit and receive terminals involving high-power boosters and Raman pumps, repeaterless systems may provide a lower overall system cost compared to repeatered systems as repeaterless systems avoid the need to power-feed, supervise and maintain costly in line erbium-doped fibre amplifiers (EDFAs). In certain repeaterless systems, Raman amplifiers are used to avoid such system complexity and costs. Generally, Raman amplification is accomplished by introducing the signal and pump energies along the same optical fiber. A Raman amplifier uses Stimulated Raman Scattering (SRS), which occurs in silica fibers when an intense pump beam propagates through it. SRS is an inelastic scattering process in which an incident pump photon loses its energy to create another photon of reduced energy at a lower frequency. The remaining energy is absorbed by the fiber medium in the form of molecular vibrations (i.e., optical phonons). That is, pump energy of a given wavelength amplifies a signal at a longer wavelength. The pump and signal may be co-propagating or counter propagating with respect to one another. Thus, optical WDM transmission up to a few hundred kilometers can be implemented using repeaterless systems making them an attractive candidate for island hopping, festoons as well as optical add-drop multiplexer (OADM) branches in transoceanic networks.

In long unrepeatered systems, the WDM channels need to be launched with higher powers from the transmitter to result in adequate optical signal-to-noise ratio (OSNR) and performance on the receive end. Various non-linear transmission effects may limit the maximum possible launch power and also as a result the system reach and capacity. Such non-linear propagation effects may limit the ultimate capacity for repeaterless WDM transmission up to about 500-600 kilometers depending on fiber losses. In repeaterless transmission systems, a combination of self-phase-modulation (SPM), cross-phase-modulation (XPM) and Raman cross-talk among edge WDM channels define the system useable bandwidth and as a result the ultimate system capacity. Briefly, SPM is a nonlinear optical effect where the phase of the transmitted light induces a varying refractive index of the fiber due to the optical Kerr effect. Raman cross-talk between signals is directly proportional to the product of their power and wavelength separation. In addition, Raman interaction is polarization sensitive. Thus, by reducing the Raman interaction between signals, improvements in capacity and reach may be realized. Accordingly, a need exists to reduce the Raman interaction between signals to increase capacity and reach in unrepeatered optical communication systems.

### BRIEF DESCRIPTION OF THE DRAWINGS

FIG. 1 is block diagram of a repeaterless optical transmission system including an orthogonal band launch transmitter in accordance with one or more embodiments;

FIG. 2 is a block diagram of an orthogonal band launch transmitter in accordance with one or more embodiments;

FIG. 3 is a diagram of the division of orthogonal band launch groups into two bands to reduce Raman interaction in a repeaterless optical transmission system in accordance with one or more embodiments;

FIG. 4 is diagram of signal power and degree of polarization versus distance in a repeaterless system in accordance with one or more embodiments; and

FIG. 5 is a diagram of a method to implement orthogonal band launch to reduce Raman interaction in a repeaterless optical transmission system in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail. In addition, the present disclosure may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

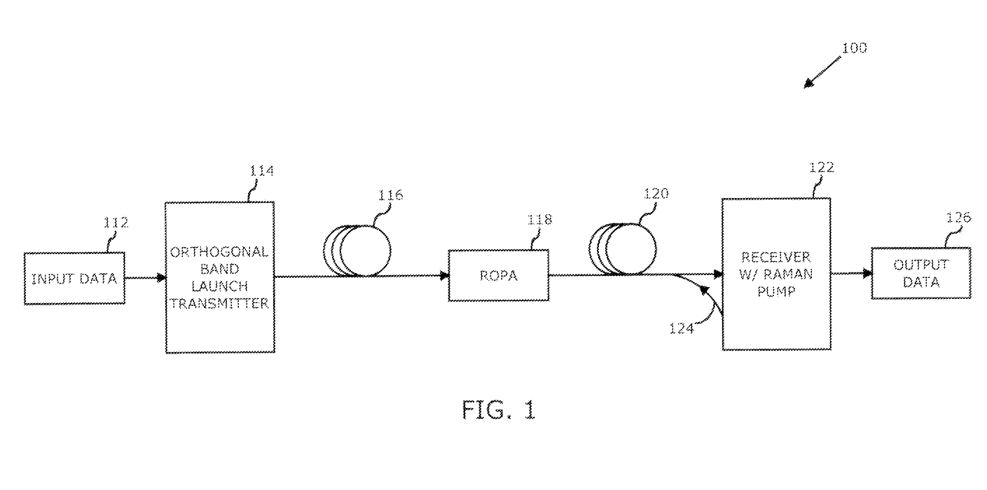

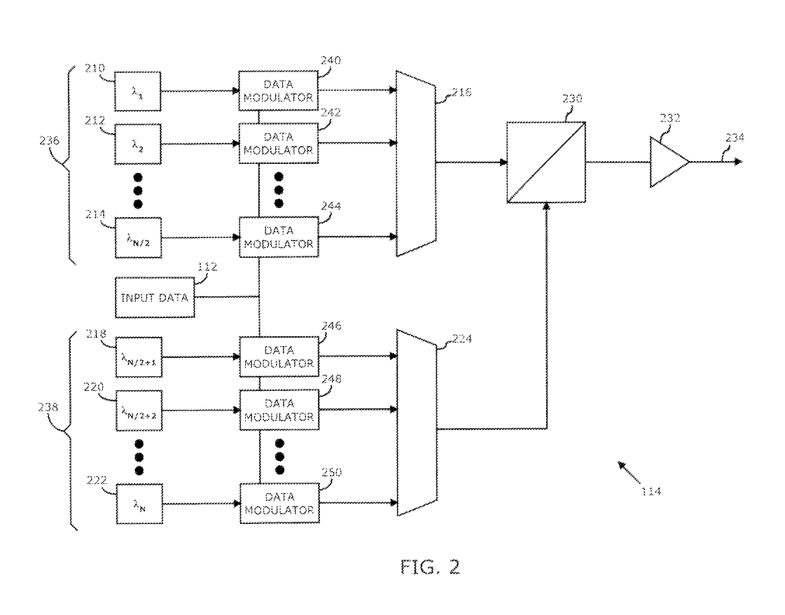

Referring now to FIG. 1, a block diagram of a repeaterless optical transmission system including an orthogonal band launch transmitter in accordance with one or more embodiments will be discussed. It should be noted that although FIG. 1 shows one example of a repeaterless optical transmission system 100 for purposes of discussion, various other versions and/or embodiments of system 100 may be utilized, with more or fewer elements than shown, and the scope of the claimed subject matter is not limited in this respect. In the system 100 shown in FIG. 1, input data 112 to be transmitted is provided to an orthogonal band launch transmitter 114. Further details of orthogonal band launch transmitter 114 are shown in and described with respect to FIG. 2, below. Orthogonal band launch transmitter 114 transmits an optical signal modulated with input data 112 via optical fiber 116 and/or via optical fiber 120 to receiver 122. In one or more embodiments, the optical signal may be modulated with input data 112 via WDM or dense wavelength-division multiplexing (DWDM), although the scope of the claimed subject matter is not limited in this respect.

In some embodiments, receiver 122 may include a Raman pump to provide Raman amplification in fiber 120, or additional gain via a Remote Optically Pumped Amplifier (ROPA) 118 disposed between optical fiber 116 and optical fiber 120. In contrast to repeatered systems that utilize optical amplifiers incorporating rare earth doped fiber amplifiers such as erbium doped fiber amplifiers (EFDAs) at multiple specific amplifier positions along optical fiber 116 and optical fiber 120, Raman amplification is more distributed and occurs throughout an optical transmission fiber when the signal in the fiber is pumped at an appropriate wavelength or wavelengths. Gain may be achieved via Raman pumping over a spectrum of wavelengths longer than the pump wavelength through a process of Stimulated Raman Scattering. The difference between the Raman amplifier pump wavelength and the peak of the associated amplified wavelength at the longer wavelength is referred to as a “Stokes shift”. The Stokes shift for a typical silica fiber is approximately 13 THz. Utilization of such a Raman pump allows optical transmission system 100 to be repeaterless in that powered optical amplifiers may be avoided. In some embodiments, at least some portion or all of optical fiber 116, ROPA 118, and/or optical fiber 120 may be disposed in a submarine environment such as an undersea deployment, although the scope of the claimed subject matter is not limited in this respect.

Upon receipt of the optical signal, receiver 122 may decode the optical signal to provide output data 126. In some embodiments, receiver 122 may perform conditioning of the optical signal prior to decoding, such as dispersion post compensation and/or optical filtering. Orthogonal band launch transmitter 114 and receiver 122 may cooperate to maximize or nearly maximize the length of optical fiber 116 and/or optical fiber 120 while minimizing adverse Raman interaction between the channels of the transmitted signal via a selected launch polarization state of the channels as will be discussed further, below.

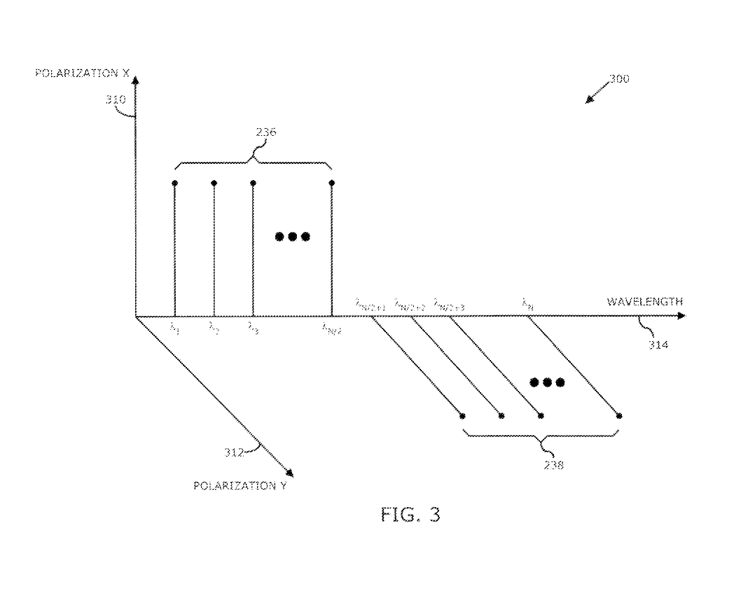

FIG. 2 is a block diagram of an exemplary orthogonal band launch transmitter in accordance with one or more embodiments of the present disclosure. FIG. 2 illustrates an example schematic diagram of a transmission setup for the orthogonal band launch sequence that is shown in and described with respect to FIG. 3, below. For a band of signals having N number of carriers, orthogonal band launch transmitter 114 may divide the carriers into a first band 236 and a second band 238. The first band 236 comprises the lower (shorter) wavelength carriers and the second band 238 comprises the higher (longer) wavelength carriers. Thus, N/2 number of optical sources such as optical source 210, optical source 212, up to optical source 214, is utilized to provide carriers for wavelength λ₁, wavelength λ₂, up to wavelength λ_{N/2} for the first band 236. In one or more embodiments, the optical sources may comprise laser diodes or other laser sources, for example vertical-cavity surface-emitting lasers, indium phosphide lasers, silicon lasers, gallium arsenide lasers, etc.

Another N/2 number of optical sources such as optical source 218, optical source 220, up to optical source 222, are utilized to provide carriers for wavelength λ_{N/2+1}, wavelength λ_{N/2+2}, up to wavelength λ_{N} for the second band 238. As an example, for 16 channels, the first one through eight shorter wavelength carriers comprise the first band 236, and the next nine through sixteen longer wavelength carriers comprise the second band 238. The carriers for first band 236 are combined via polarization maintaining coupler 216, and the carriers for the second band 238 are combined via polarization maintaining coupler 224. Thus, in the example shown in FIG. 2, the signal band to be transmitted may be divided into two bands, a first band 236 comprising the lower wavelength carriers, and a second band 238 comprising the higher wavelength carriers. With respect to the first band 236, each of the wavelengths λ₁, wavelength λ₂, up to wavelength λ_{N/2} from respective optical sources 210, 212 . . . 214 is independently modulated with input data 112 using data modulators 226₁ . . . 226_{N} respectively to form modulated optical signals. For example, wavelength λ₁ from optical source 210 is modulated with input data 112 via data modulator 240. Similarly, wavelength λ₂ from optical source 212 is modulated with input data 112 via data modulator 242 and so on to wavelength λ_{N/2} from optical source 214. The modulated signals from each of the data modulators 240, 242 . . . 244 are combined via polarization maintaining coupler 216 and supplied to polarization beam combiner 230. Each of the optical paths between optical sources 210, 212 . . . 214, data modulators 240, 242 . . . 244, polarization maintaining coupler 216 to polarization beam combiner 230 maintain the polarization of the supplied optical signal.

With respect to the second band 238, each of the wavelengths λ_{N/2+1} wavelength λ_{N/2+2}, up to wavelength λ_{N} from respective optical sources 218, 220 . . . 222 is independently modulated with input data 112 using data modulators 246, 248 . . . 250 respectively to form modulated optical signals for the second band. For example, wavelength λ_{N/2+1} from optical source 218 is modulated with input data 112 via data modulator 246. Similarly, wavelength λ_{N/2+2} from optical source 220 is modulated with input data 112 via data modulator 248 and so on to wavelength λ_{N} from optical source 222. The modulated signals from each of the data modulators 246 . . . 248 are combined via polarization maintaining coupler 224 and supplied to polarization beam combiner 230. Each of the optical paths between optical sources 218, 220 . . . 222, data modulators 246, 248 . . . 250, polarization maintaining coupler 224 to polarization beam combiner 230 maintain the polarization of the supplied optical signal. In one or more embodiments, each data modulator 240 . . . 244 and/or 246 . . . 250 may comprise return-to-zero differential phase-shift keying (RZ-DPSK) modulators or the like such as differential quadrature phase-shift keying (DQPSK), although the scope of the claimed subject matter is not limited in this respect.

The outputs of polarization maintaining couplers 216 and 224 may be combined via polarization beam combiner 230 or similar device to optically combine the modulated first band 236 and second band 238 into a combined optical signal to be transmitted via optical fiber 116 and/or optical fiber 120 as shown in FIG. 1. It should be noted that, as shown in and described further with respect to FIG. 3, below, polarization beam combiner 230 combines first band 236 and second band 238 such that the modulated carriers in first band 236 have a first polarization state and the modulated carriers in second band 238 have a second polarization state that is orthogonal to the first polarization state. Optionally, the combined optical signal may be amplified via a high-power booster 232 to a desired power level at output 234 to provide an orthogonal band launch of the optical signal. Additionally, a pre-dispersion compensation module (not shown) containing dispersion compensation fiber (DCF) may be disposed between polarization beam combiner 230 and high-power booster 232 to introduce dispersion into the combined optical signal. However, the effectiveness of pre-dispersion compensation may be limited since DCF is not polarization maintaining and negatively impacts the orthogonality between first and second bands 236 and 238. The use of such pre-dispersion compensation module may be dependent on the type modulation format employed in data modulators 240 . . . 244 and/or 246 . . . 250.

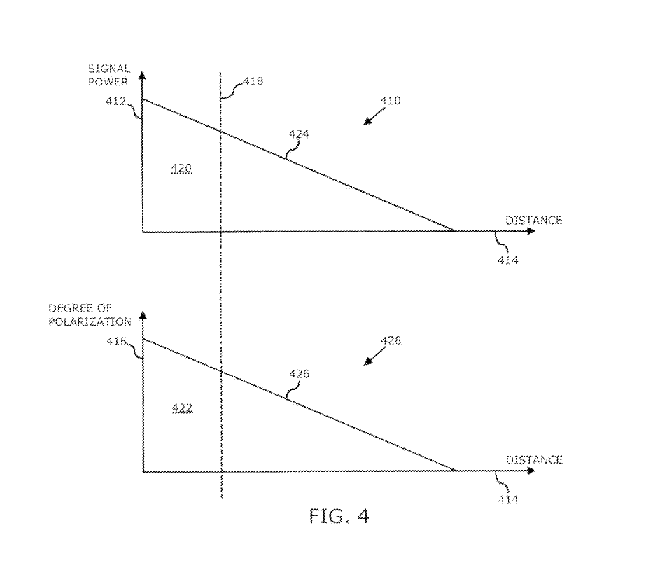

With an orthogonal band launch, signals in first band 236 are launched with states of polarization that are orthogonal to the states of polarization of signals in the second band 238. As a result, the polarization states between the shortest wavelengths and the longest wavelengths are orthogonal where Raman interaction will be the strongest, such that Raman interaction is reduced and/or minimized. Such a result is shown in and described with respect to FIG. 4, below, which illustrates how orthogonal band launch is preserved in a repeaterless optical transmission system 100 in the presence of polarization mode dispersion. Polarization mode dispersion (PMD) is a differential time of flight for different polarizations through an optical path such as a single-mode fiber. PMD can degrade the average performance of an optical transmission system, and can cause the performance to fluctuate with time. One of the deleterious manifestations of PMD is a degraded waveform or distortion that can change with time. An example orthogonal band launch arrangement capable of reducing Raman interaction between the carriers is shown in and described with respect to FIG. 3, below.

Referring now to FIG. 3, a diagram of the division of orthogonal band launch groups into two bands to reduce Raman interaction in a repeaterless optical transmission system in accordance with one or more embodiments will be discussed. FIG. 3 illustrates an exemplary orthogonal band launch scheme as discussed herein. Polarization state in a first direction is shown on axis 310 (POLARIZATION X) and polarization state in a second direction is shown on axis 312 (POLARIZATION Y) wherein axis 310 and axis 312 are orthogonal. Wavelength of the signal carriers is shown along axis 314 (WAVELENGTH). As shown in FIG. 1, an orthogonal band launch arrangement divides the launched signal into two distinct bands, a first band 236 of lower (shorter) wavelength carriers and a second band 238 of higher (longer) wavelength carriers. The lower half of the spectrum in first band 236 is in a first polarization state, and the upper half of the spectrum in second band 238 is in a second polarization orthogonal state orthogonal to the first polarization state. Such an arrangement of the polarization state of first band 236 with respect to the polarization state of second band 238 reduces both the bandwidth and power in any polarization state leading to enhanced transmission performance through reduced Raman interaction. FIG. 4, below, illustrates how such an orthogonal band launch scheme preserves a reduced Raman interaction in a repeaterless optical transmission systems 100 in the presence of polarization mode dispersion.

Referring now to FIG. 4, a diagram of signal power and polarization versus distance in a repeaterless system in accordance with one or more embodiments will be discussed. An ideal optical fiber is perfectly circular in shape and thus all polarizations propagate identically along the optical fiber. However in practice, optical fibers may have at least some asymmetries and/or birefringences that result in polarization mode dispersion (PMD) such that polarizations do not propagate identically, resulting in a change of one polarization state with respect to another along the length of the fiber. The optical band launch scheme as discussed herein is capable of achieving reduced Raman interaction even in the presence of such polarization mode dispersion.

Graph 410 of FIG. 4 shows signal power along axis 412 versus transmission distance 414, and graph 428 of FIG. 4 shows degree of polarization 416 versus distance 414. As shown with plot 424, as the signal propagates along optical fiber 116, signal power is attenuated and the Raman interaction between channels reduces with increasing distance. Hence, of the strongest Raman interaction occurs in optical fiber 116 in region 420 close to orthogonal band launch transmitter 114. The orthogonal band launch scheme still yields benefit because, as shown with plot 426, the degree of polarization of the signal is strong and remains sufficiently orthogonal in region 422 close to orthogonal band launch transmitter 114 across the entire band. Thus, as a result of the orthogonal band launch scheme, when Raman interaction is strongest the degree of polarization is high, however the orthogonally launched bands as shown in FIG. 3 are less susceptible to Raman interaction due to the orthogonal polarization arrangement of the carriers. Eventually, the signals become significantly depolarized with respect to each other with increasing distance along the optical fiber 116, however as the degree of polarization decreases and the bands become less orthogonally polarized, the signal powers have reduced sufficiently so that less Raman interaction accordingly will take place. As a result, the orthogonal band launch scheme discussed herein is capable of achieving successful reduction of Raman interaction even in the presence of polarization mode dispersion, although the scope of the claimed subject matter is not limited in this respect.

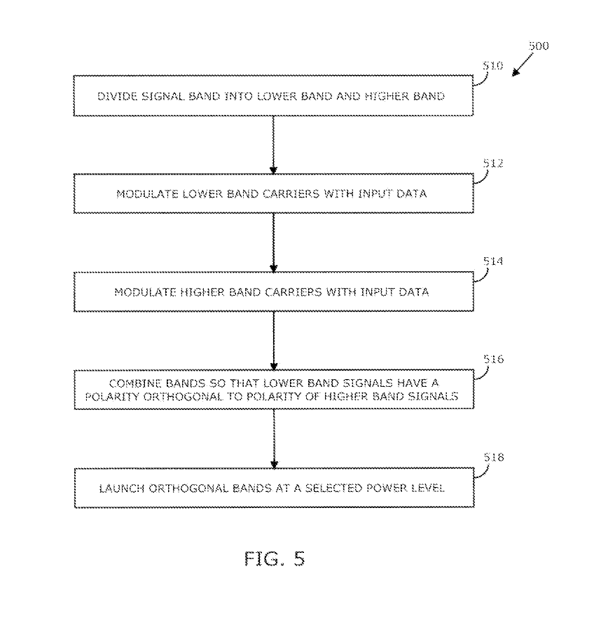

Referring now to FIG. 5, a diagram of a method to implement orthogonal band launch to reduce Raman interaction in a repeaterless optical transmission system in accordance with one or more embodiments will be discussed. It should be noted that although FIG. 5 shows one particular order of the elements of method 500 as just one example, alternative orders of method 500 may likewise be implemented, and method 500 may include more or fewer elements than shown in FIG. 5, and further may be executed with the structure shown in and described herein or variations thereof, and the scope of the claimed subject matter is not limited in these respects. As shown in FIG. 5, the signal band may be divided at block 510 into a lower band of signal carriers and a higher band of signal carriers. The lower band of carriers may be modulated with input data 112 at block 512, and the higher band of carriers may be modulated with input data 112 at block 514. The lower band of modulated carriers may be combined with the higher band of modulated carriers at block 516 so that the lower band signals have a first polarity that is orthogonal, or nearly orthogonal, to the polarity of the higher band signals. The combined orthogonal bands may then be launched at block 518 at a selected power level for repeaterless transmission on an optical fiber such as optical fiber 116 and/or optical fiber 120 of repeaterless optical transmission system 100 of FIG. 1.

Although the claimed subject matter has been described with a certain degree of particularity, it should be recognized that elements thereof may be altered by persons skilled in the art without departing from the spirit and/or scope of claimed subject matter. It is believed that the subject matter pertaining to orthogonal band launch for repeaterless systems and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An orthogonal band launch transmitter, comprising:
a first group of optical sources to generate a first band of carriers, and a second group of optical sources to generate a second band of carriers,
a first plurality of data modulators each associated with a corresponding one of the first group of optical sources to modulate the first band of carriers with input data and form a first band of modulated carriers;
a second plurality of data modulators each associated with a corresponding one of the second group of optical sources to modulate the second band of carriers with the input data and form a second band of modulated carriers; and
a polarizing beam combiner to combine the first band of modulated carriers with the second band of modulated carriers to provide a combined output signal, wherein the first band of modulated carriers has a polarization state that is orthogonal to a polarization state of the second band of modulated carriers.

2. An orthogonal band launch transmitter as claimed in claim 1, wherein the carriers comprise N number of carriers, the first band of carriers comprises carriers having wavelength number 1 through wavelength number N/2, and the second band of carriers comprises carriers having wavelength number N/2+1 up to wavelength number N.

3. An orthogonal band launch transmitter as claimed in claim 1, further comprising a high-power booster to receive an output from the polarizing beam combiner to launch the combined output signal to a desired power level.

4. An orthogonal band launch transmitter as claimed in claim 1, wherein said first plurality of data modulators or the second plurality of data modulators, or combinations thereof, comprise a wavelength-division multiplexer, a dense wavelength-division multiplexer, a phase-shift keying modulator, a differential phase-shift keying modulator, return-to-zero differential phase-shift keying modulator or a differential quaternary phase-shift keying modulator, or combinations thereof.

5. An orthogonal band launch transmitter as claimed in claim 1, wherein at least one or more of the optical sources comprises a laser diode.

6. An orthogonal band launch transmitter as claimed in claim 1, further comprising a first coupler to combine the first band of carriers, and a second coupler to combine the second band of carriers.

7. An orthogonal band launch transmitter as claimed in claim 1 wherein carriers in the first band comprise shorter wavelength carriers, and carriers in the second band comprise longer wavelength carriers

8. A method, comprising:
dividing a band of signal carriers into a first band of carriers and a second band of carriers, wherein carriers in the first band comprise shorter wavelength carriers, and carriers in the second band comprise longer wavelength carriers;
modulating each of the first band of carriers with an input signal;
modulating each of the second band of carriers with the input signal;
combining the first band of modulated carriers with the second band of modulated carriers into a combined signal, wherein the first band has a polarization state that is orthogonal, or nearly orthogonal, to a polarization of the second state; and
transmitting the combined signal over an optical transmission system.

9. A method as claimed in claim 8, wherein the carriers comprise N number of carriers, the first band of carriers comprising carriers having wavelength number 1 through wavelength number N/2, and the second band of carriers comprising carriers having wavelength number N/2+1 up to wavelength number N.

10. A method as claimed in claim 8, further comprising boosting a power of the combined signal to a desired power level prior to said transmitting.

11. A method as claimed in claim 8, said modulating each of the first band of carriers or said modulating each of the second band of carriers, or combinations thereof, comprising wavelength-division multiplexing, dense wavelength-division multiplexing, phase-shift keying, differential phase-shift keying, return-to-zero differential phase-shift keying, or differential quaternary phase-shift keying modulating, or combinations thereof.

12. A method as claimed in claim 8, wherein at least one or more of the optical sources comprises a laser diode.

13. A method as claimed in claim 8, wherein combining the first band of modulated carriers with the second band of modulated carriers into a combined signal comprises coupling the first band of modulated carriers into first modulated signals, and coupling the second band of modulated carriers into second modulated signals and combining the first modulated signals and the second modulated signals.

14. A repeaterless optical transmission system, comprising:
an orthogonal band launch transmitter to transmit an optical signal;
an optical fiber to carry the optical signal transmitted by the orthogonal band launch transmitter; and
a receiver to receive the optical signal from the optical fiber;
wherein the orthogonal band launch transmitter comprises:
a first group of optical sources to generate a first band of carriers, and a second group of optical sources to generate a second band of carriers;
a first plurality of data modulators each associated with a corresponding one of the first group of optical sources to modulate the first band of carriers with input data and form a first band of modulated carriers;
a second plurality of data modulators each associated with a corresponding one of the second group of optical sources to modulate the second band of carriers with the input data and form a second band of modulated carriers; and
a polarizing beam combiner to combine the first band of modulated carriers with the second band of modulated carriers to provide a combined output signal, wherein the first band of modulated carriers has a polarization state that is orthogonal to a polarization state of the second band of modulated carriers.

15. A repeaterless optical transmission system as claimed in claim 14, further comprising a remote optically pumped amplifier disposed along the optical fiber, wherein the receiver includes a Raman pump to pump the remote optically pumped amplifier.

16. A repeaterless optical transmission system as claimed in claim 14, wherein the carriers comprise N number of carriers, the first band of carriers comprises carriers having wavelength number 1 through wavelength number N/2, and the second band of carriers comprises carriers having wavelength number N/2+1 up to wavelength number N.

17. A repeaterless optical transmission system as claimed in claim 14, said orthogonal band launch transmitter further comprising a high-power booster to receive an output from the polarizing beam combiner to launch the combined output signal to a desired power level.

18. A repeaterless optical transmission system as claimed in claim 14, wherein said first plurality of data modulators or the second plurality of data modulators, or combinations thereof, comprise a wavelength-division multiplexer, a dense wavelength-division multiplexer, a phase-shift keying modulator, a differential phase-shift keying modulator, return-to-zero differential phase-shift keying modulator or a differential quaternary phase-shift keying modulator, or combinations thereof.

19. A repeaterless optical transmission system as claimed in claim 14, said orthogonal band launch transmitter further comprising a first coupler to combine the first band of carriers for the first data modulator, and a second coupler to combine the second band of carriers for the second data modulator.

20. A repeaterless optical transmission system as claimed in claim 14, wherein said optical fiber does not utilize a repeater.
